(19) United States
(12) Patent Application Publication
(10) Pub. No.: US 2022/0332928 A1
(43) Pub. Date: Oct. 20, 2022

(54) SEMICONDUCTIVE POLYMER COMPOSITION

(71) Applicant: BOREALIS AG, Vienna (AT)

(72) Inventors: Daniel NILSSON, Stenungsund (SE); Niklas THORN, Stenungsund (SE); Annika SMEDBERG, Stenungsund (SE); Emelie ANDERSSON, Stenungsund (SE)

(21) Appl. No.: 17/640,916

(22) PCT Filed: Sep. 11, 2020
(86) PCT No.: PCT/EP2020/075473

§ 371 Date: Mar. 7, 2022

(30) Foreign Application Priority Data
Sep. 13, 2019 (EP) 19197247.0

(51) Int. Cl. C08L 23/08; H01B 1/12

(52) U.S. Cl. CPC C08L 23/0853; H01B 1/12; C08L 2203/202; C08L 2205/025; H01B 9/00

(57) ABSTRACT

The invention provides a semiconductive polymer composition comprising a) at least 30 wt% of an ethylene vinyl acetate copolymer; b) at least 25 wt% carbon black; and c) at least 2 wt% of an ethylene vinyl acetate copolymer with an MFR2 of at least 100 g/10 min; with the proviso that components (a) and (c) are different.

### Field of the Invention

The present invention relates to a semiconductive polymer composition, to an optionally crosslinkable cable comprising said composition and, if crosslinkable, then to a crosslinked cable comprising said composition, as well as to the preparation method of a cable comprising said composition, the method including an optional crosslinking step of the cable. The present invention further relates to a process for producing the semiconductive polymer composition.

### Background

In wire and cable (W&C) applications a typical cable comprises at least one conductor surrounded by one or more layers of polymeric materials. In power cable applications, including medium voltage (MV), high voltage (HV) and extra high voltage (EHV) applications, said conductor is surrounded by several layers including an inner semiconductive layer, an insulation layer and an outer semiconductive layer, in that order. To these layers, further layer(s) may be added, such as screen(s) and/or auxiliary barrier layer(s), e.g. one or more water barrier layer(s) and one or more jacketing layer(s).

Furthermore, the electrical properties, which are of importance, may differ in different cable applications, as is the case between alternating current (AC) and direct current (DC) cable applications.

Typical cables are commonly produced by extruding the layers on a conductor. Such polymeric semiconductive layers are well known and widely used in dielectric power cables rated for voltages greater than 6 kV. These layers are used to provide layers of intermediate resistivity between the conductor and the insulation, and between the insulation and the ground or neutral potential.

Further, it is also known that crosslinking of polymers, e.g. polyolefins, substantially contributes to an improved heat and deformation resistance, mechanical strength, chemical resistance and abrasion resistance of a polymer. Therefore crosslinked polymers are widely used in different end applications, such as in the mentioned wire and cable (W&C) applications.

The purpose of a semiconductive layer is to provide a smooth interface to the electric field in the insulation thereby prolonging the service life, i.e. long term viability, of a power cable i.a. by preventing partial discharge at the interface of conductive and dielectric layers.

Semiconductive compositions are produced in a compounding process where polymer, carbon black, and other additives are compounded at elevated temperatures. The resultant semiconductive polymer compositions have high requirements on smoothness.

Semiconductive compositions using EVA as one of the polymer components are well known in the art. It is also known that at elevated temperatures the EVA copolymer is susceptible to thermal degradation, leading to the formation of acetic acid and unsaturations on the polymer backbone (B.Sultan et.al, J.App.Pol.Sci., Vol 43, Issue 9, p. 1737). The formation of acetic acid is not desirable as it can lead to corrosion in the production equipment. Further, unsaturations on the polymer backbone are not desired as such moieties are sensitive to thermooxidative degradation.

Another critical characteristic is the smoothness of the semiconductive composition. The smoothness is partially influenced i.a. by carbon black (CB) which is routinely employed in such composition. An uneven distribution of the particle size of carbon black particles, for example, can reduce surface smoothness and cause localised electrical stress concentration which is a defect that can initiate a phenomenon well known as vented trees. Moreover, the surface properties and particle size of the CB may affect the surface smoothness of the semiconductive layer of a power cable. For example, it is known that the larger the CB particles, the smoother the surface of the semiconductive layer. However, increasing the particle size of a CB for improving smoothness in turn deteriorates, i.e increases, the resistivity of the semiconductive layer material. Thus, these properties need often be balanced, especially in case of so called furnace carbon black.

In order to address the above-mentioned deficiencies with the current semiconductive compositions comprising EVA it is desirable to provide a composition which can be produced at lower compounding temperatures without any loss in compounding output. Ideally, such a composition will have sufficient smoothness to be considered suitable for use in power cables. In this regard, the present inventors have surprisingly found that is beneficial to include acid scavengers, such as stearates, and/or an ethylene vinyl acetate copolymer with MFR2 of at least 100 g/10 min into semiconductive polymer compositions.

### SUMMARY OF THE INVENTION

Thus, in a first aspect, the invention provides a semiconductive polymer composition comprising:

(a) at least 30 wt% of an ethylene vinyl acetate copolymer;

(b) at least 25 wt% carbon black; and

(c) at least 2 wt% of an ethylene vinyl acetate copolymer with an MFR₂ of at least 100 g/10 min;

with the proviso that components (a) and (c) are different.

In a particular embodiment, the invention further provides a semiconductive polymer composition as hereinbefore defined further comprising at least 0.1 wt% of an acid scavenger.

In a second aspect, the invention provides an article comprising semiconductive layer(s) which is/are obtained from a semiconductive polymer composition as hereinbefore defined, wherein the article is, for example, a cable, e.g. a power cable.

In a further aspect, the invention provides a process for preparing a semiconductive polymer composition comprising:

(a) at least 30 wt% of an ethylene vinyl acetate copolymer;

(b) at least 25 wt% carbon black; and

(c) at least 2 wt% of an ethylene vinyl acetate copolymer with an MFR₂ of at least 100 g/10 min and/or at least 0.1 wt% of an acid scavenger.

said process comprising compounding (a) to (c) at a temperature of less than 240 ° C., with the proviso that, when present, the ethylene vinyl acetate copolymer (c) is different to the ethylene vinyl acetate copolymer (a).

In a final aspect, the invention provides the use of an ethylene vinyl acetate copolymer with an MFR₂ of at least 100 g/10 min and/or an acid scavenger for reducing the compounding temperature of a semiconductive polymer composition.

### DETAILED DESCRIPTION

Definitions

Semiconductive polymer composition means herein that the polymer composition contains a conductive filler, such as e.g. carbon black in a semiconductive amount. The term semiconductive polymer composition is a well-known expression for polymer compositions used in semiconductive applications, such as in semiconductive layers of cables, as well known for a skilled person.

The term “polyethylene” will be understood to mean an ethylene based polymer, i.e. one comprising at least 50 wt% ethylene, based on the total weight of the polymer as a whole. The terms “polyethylene” and “ethylene-based polymer,” are used interchangeably herein, and mean a polymer that comprises a majority weight percent polymerized ethylene monomer (based on the total weight of polymerisable monomers), and optionally may comprise at least one polymerised comonomer. The ethylene-based polymer may include greater than 50, or greater than 60, or greater than 70, or greater than 80, or greater than 90 weight percent units derived from ethylene (based on the total weight of the ethylene-based polymer). The low density polyethylene, LDPE, of the invention is a polyethylene produced in a high pressure process. Typically the polymerization of ethylene and optional further comonomer(s) in a high pressure process is carried out in the presence of an initiator(s). The meaning of the term LDPE is well known and documented in the literature. The term LDPE describes and distinguishes a high pressure polyethylene from low pressure polyethylenes produced in the presence of an olefin polymerisation catalyst. LDPEs have certain typical features, such as different branching architecture. A typical density range for an LDPE is 0.900 to 0.960 g/cm³.

The term “conductor” means herein a conductor comprising one or more wires. The wire can be for any use and be e.g. optical, telecommunication or electrical wire. Moreover, the cable may comprise one or more such conductors. Preferably the conductor is an electrical conductor and comprises one or more metal wires.

The weight content of components (a) to (c) specified in the description and claims is based on the total weight of the semiconductive polymer composition.

Ethylene vinyl acetate copolymer (a)

The ethylene vinyl acetate copolymer (a) within the context of the present invention is a polyethylene, i.e. comprises ethylene as the major monomer component. The polyethylene copolymer (a) comprises vinyl acetate as a comonomer and may contain one or more further comonomer(s). As well known “comonomer” refers to copolymerisable comonomer units.

The ethylene vinyl acetate copolymer (a) is produced in a high pressure polymerisation process, preferably by radical polymerisation in the presence of an initiator(s). Thus, the copolymer (a) is a low density polyethylene (LDPE). It is to be noted that a polyethylene produced in a high pressure (HP) is referred herein generally as LDPE and which term has a well-known meaning in the polymer field. Although the term LDPE is an abbreviation for low density polyethylene, the term is understood not to limit the density range, but covers the LDPE-like HP polyethylenes with low, medium and higher densities. The term LDPE describes and distinguishes only the nature of HP polyethylene with typical features, such as high branching degree.

The preferred ethylene vinyl acetate copolymer (a) is an LDPE copolymer, i.e. a low density copolymer of ethylene, vinyl acetate and optionally one or more other comonomer(s) (referred herein as EVA copolymer). The one or more other comonomers, if present, of the EVA copolymer are preferably selected from the polar comonomer(s), non-polar comonomer(s) or from a mixture of the polar comonomer(s) and non-polar comonomer(s), as defined below. Moreover, said EVA copolymer may optionally be unsaturated. It should be understood that, if one or more other comonomers are present, the vinyl acetate comonomer is in the majority compared to any other comonomer present in the composition.

In one preferred embodiment, the one or more other comonomers comprises a polar comonomer. By “polar” comonomer, it is meant a comonomer comprising at least one polar bond and which has a net electric dipole, i.e. a region of net positive charge and a region of net negative charge.

As a polar comonomer of the one or more other comonomers, compound(s) containing hydroxyl group(s), alkoxy group(s), carbonyl group(s), carboxyl group(s), ether group(s) or ester group(s), or a mixture thereof can used. More preferably, comonomer(s) containing carboxyl and/or ester group(s) are used as said polar comonomer, if present. Still more preferably, the optional polar comonomer(s) of EVA copolymer is selected from the groups of acrylate(s), methacrylate(s) or acetate(s), or any mixtures thereof.

If present in said EVA copolymer, the polar comonomer(s) is preferably selected from the group of alkyl acrylates, alkyl methacrylates, or a mixture thereof. Further preferably, said polar comonomer(s) are selected from C₁- to C₆-alkyl acrylates, C₁- to C₆- alkyl methacrylates. Still more preferably, said polar EVA copolymer is a copolymer of ethylene with C₁- to C₄-alkyl acrylate, such as methyl, ethyl, propyl or butyl acrylate, or any mixture thereof, more preferably a copolymer of ethylene with methyl, ethyl or butyl acrylate, or any mixture thereof.

As the optional non-polar comonomer(s) for the EVA copolymer as the preferred copolymer (a), comonomer(s) other than the above defined polar comonomers can be used. Preferably, the non-polar comonomers are other than comonomer(s) containing hydroxyl group(s), alkoxy group(s), carbonyl group(s), carboxyl group(s), ether group(s) or ester group(s). One group of preferable non-polar comonomer(s) comprise, preferably consist of, monounsaturated (=one double bond) comonomer(s), preferably olefins, preferably alpha-olefins, more preferably C₃ to C₁₀ alpha-olefins, such as propylene, 1-butene, 1-hexene, 4-methyl-l-pentene; polyunsaturated (=more than one double bond) comonomer(s) such as 1,7-octadiene, 1,9-decadiene, 1,11-dodecadiene, 1,13-tetradecadiene, 7-methyl-1,6-octadiene, 9-methyl-1,8-decadiene, or mixtures thereof; a silane group containing comonomer(s); or any mixtures thereof.

As mentioned above, the EVA copolymer may optionally be unsaturated, i.e. it may comprise carbon-carbon double bonds (-C=C-). The unsaturation can be provided by one or more of the following means: by a chain transfer agent (CTA), by one or more polyunsaturated comonomer(s) or by polymerisation conditions.

That the ethylene vinyl acetate copolymer (a) is “unsaturated” means herein that the copolymer comprises carbon carbon double bonds. Carbon carbon double bonds mean herein unsaturations. The polyethylene, as described herein, may comprise vinyl groups, for example, allyl groups. Vinyl groups are functional groups which comprise carbon carbon double bonds. The term “vinyl group” as used herein takes is conventional meaning, i.e. the moiety “-CH=CH₂”. Further, the polyethylene may in addition comprise other functional groups also comprising carbon carbon double bonds. The other functional groups, also comprising carbon carbon double bonds, may be, e.g., vinylidene groups and/or vinylene groups. The vinylene group has either a cis or trans configuration. For the avoidance of doubt, vinylidene groups and vinylene groups are not vinyl groups as the terms are used herein. Typically said unsaturated polyolefins have a double bond content of more than 0.1 double bonds/1000 C-atoms.

Still a further embodiment according to the present invention discloses a semiconductive polymer composition, wherein ethylene vinyl acetate copolymer (a) optionally comprises unsaturation provided by, for example, copolymerising ethylene with vinyl acetate and at least one polyunsaturated comonomer (i.e. to produce a terpolymer) and/or by, for example, using a chain transfer agent, e.g. propylene.

It is well known that e.g. propylene can be used as a comonomer or as a chain transfer agent (CTA), or both, whereby it can contribute to the unsaturation, e.g. the amount of the vinyl groups in the polyethylene. Herein, when copolymerisable CTA, such as propylene, is used, the copolymerised CTA is not calculated to the origin comonomer content.

The polyunsaturated comonomers suitable for the optional unsaturated ethylene vinyl acetate copolymer (a) preferably consist of a straight carbon chain with at least 8 carbon atoms and at least 4 carbons between the non-conjugated double bonds, of which at least one is terminal, more preferably, said polyunsaturated comonomer is a diene, preferably a diene which comprises at least eight carbon atoms, the first carbon-carbon double bond being terminal and the second carbon-carbon double bond being non- conjugated to the first one. Preferred dienes are selected from C₈ to C₁₄ non-conjugated dienes or mixtures thereof, more preferably selected from 1,7-octadiene, 1,9-decadiene, 1,11-dodecadiene, 1,13-tetradecadiene, 7-methyl-1,6-octadiene, 9-methyl-1,8-decadiene, or mixtures thereof. Even more preferably, the diene is selected from 1,7-octadiene, 1,9- decadiene, 1,11-dodecadiene, 1,13-tetradecadiene, or any mixture thereof.

Typically, and preferably in wire and cable (W&C) applications, the density of the copolymer (a), preferably of the preferred EVA copolymer, is higher than 900 kg/m³. Preferably the density of the copolymer, preferably of the preferred EVA copolymer, is not higher than 960 kg/m³. Typical density ranges include 900 to 960 kg/m³, such as 910 to 950 kg/m³, e.g. 920 to 945 kg/m³.

The MFR₂ (2.16 kg, 190 ° C.) of the copolymer (a), preferably of the preferred EVA copolymer depends on the desired end use application as well known for a skilled person. Preferably, the MFR₂(2.16 kg, 190 ° C.) of the copolymer (a), preferably of the preferred EVA copolymer, is up to 150 g/10 min, such as up to 100 g/10 min. Typical ranges are from 0.01 to 50, preferably from 0.05 to 40 g/10 min, more preferably from 0.1 to 30 g/10 min, such as from 0.5 to 20 g/10 min, e.g. from 1 to 15 g/10 min.

Ideally, the MFR₂ of the ethylene vinyl acetate copolymer (a) is less than the MFR₂ of the ethylene vinyl acetate copolymer (c).

The melting temperature of the copolymer (a) is typically above 50 ° C., more preferably above 60 ° C. and most preferably is 80° C. or higher. The melting temperature of the copolymer (a) is preferably below 125 ° C., more preferably below 120 ° C., more preferably below 115 ° C.

Whilst it is within the ambit of the invention for the ethylene vinyl acetate copolymer (a) to comprise one or more comonomers in addition to vinyl acetate, it is preferred if the only comonomer is vinyl acetate, i.e. the copolymer consists of ethylene and vinyl acetate monomer units. Where other comonomers are present, these may be selected from any of those described above as optional “polar” or “non-polar” comonomers. Preferably, the ethylene vinyl acetate copolymer (a) is not a mix or blend of different ethylene vinyl acetate copolymers.

The total comonomer content of the copolymer (a), preferably EVA copolymer as the preferred copolymer (a), is preferably up to 70 wt%, more preferably up to 60 wt%, such as up to 50 wt%. Typically, the comonomer content is in the range 0.001 to 50 wt%, more preferably 0.05 to 40 wt%, still more preferably less than 35 wt%, still more preferably less than 30 wt%, more preferably less than 25 wt%, relative to the total weight of the copolymer. Typical ranges include 0.5 to 40 wt%, preferably of 1 to 35 wt%, more preferably 2 to 30 wt%, such as 3 to 25 wt%, e.g. 5 to 20 wt% of the total amount of said copolymer.

The vinyl acetate content in copolymer (a) is preferably in the range 1 to 35 wt%, more preferably 1.5 to 32 wt%, more preferably 2 to 28 wt%, more preferably 2.5 to 25 wt%, even more preferably 3 to 22 wt%, such as 4 to 20 wt%, especially 5 to 19 wt%, such as 10 to 18 wt%, e.g. 12 to 16 wt% relative to the total weight of the copolymer.

Accordingly, the preferred ethylene vinyl acetate copolymer (a) of the invention is a LDPE copolymer and is preferably produced at high pressure by free radical initiated polymerisation (referred to as high pressure (HP) radical polymerization). The HP reactor can be e.g. a well-known tubular or autoclave reactor or a combination thereof, preferably a tubular reactor. The high pressure (HP) polymerisation and the adjustment of process conditions for further tailoring the other properties of the polyolefin depending on the desired end application are well known and described in the literature, and can readily be used by a skilled person. Suitable polymerisation temperatures range up to 400 ° C., preferably from 80 to 350° C. and pressure from 70 MPa, preferably 100 to 400 MPa, more preferably from 100 to 350 MPa. Pressure can be measured at least after compression stage and/or after the tubular reactor. Temperature can be measured at several points during all steps.

After the separation the obtained LDPE is typically in a form of a polymer melt which is normally mixed and pelletized in a pelletising section, such as pelletising extruder, arranged in connection to the HP reactor system. Optionally, additive(s), such as antioxidant(s), can be added in this mixer in a known manner.

Further details of the production of ethylene (co)polymers by high pressure radical polymerization can be found i.a. in the Encyclopedia of Polymer Science and Engineering, Vol. 6 (1986), pp 383-410 and Encyclopedia of Materials: Science and Technology, 2001 Elsevier Science Ltd.: “Polyethylene: High-pressure, R.Klimesch, D.Littmann and F.-O. Mähling pp. 7181-7184.

The ethylene vinyl acetate copolymer (a) is present in the semiconductive polymer compositions of the invention in an amount of at least 30 wt%, or at least 40 wt% or at least 50 wt% relative to the total weight of the composition as a whole. Preferable amounts may be in the range 30 to 73 wt%, more preferably 30 to 70 wt%, such as 32 to 68 wt%, e.g. 35 to 65 wt% or 45 to 60 wt%.

Carbon Black (b)

The semiconductive polymer composition of the invention comprises at least 25 wt% carbon black. Depending on the desired use, the conductivity of the carbon black and conductivity of the composition, the amount of carbon black can vary. The semiconductive polymer composition comprises, for example, 25 to 60 wt%, preferably 28 to 55 wt%, more preferably 30 to 50 wt%, e.g. 35 to 45 wt%, carbon black, based on the total weight of the semiconductive polymer composition.

According to at least one example embodiment, the carbon black is present in an amount of at least 25 wt%, such as at least 30 wt%, or at least 35 wt%, relative to the total weight of the semiconductive compositions. Preferably, the carbon black content in the semiconductive compositions does not exceed 45 wt%, or does not exceed 40 wt% relative to the total weight of the semiconductive compositions. Thus, the carbon black may be present in an amount of 25 to 45 wt%, or 25 to 40 wt%, or 30 to 45 wt%, or 30 to 40 wt%, or 34 to 41 wt% relative to the total weight of the semiconductive compositions.

Any carbon black which is electrically conductive can be used. Typically, the carbon black will be a speciality carbon black or a P-type black. Non-limiting examples of suitable carbon blacks include furnace blacks and acetylene blacks. The carbon black may have a nitrogen adsorption surface area (NSA) of 5 to 400 m2/g, for example of 10 to 300 m2/g, e.g. of 30 to 200 m2/g, when determined according to ASTM D6556-19. Further, the carbon black may have one or more of the following properties: i) a primary particle size of at least 5 nm, e.g. 10 to 30 nm, or 11-20 nm which is defined as the average particle diameter according to ASTM D3849-14, ii) iodine adsorption number of at least 10mg/g, for example 10 to 300 mg/g, such as 30 to 250 mg/g, e.g. 60 (or 61) to 200 mg/g, or 80 to 200 mg/g, or 100 to 170 mg/g, when determined according to ASTM D-1510-19; and/or iii) oil absorption number (OAN) of at least 30 ml/100g, for example 50 to 300 ml /100g, e.g. 50 to 250 ml /100g, for example 70 to 200 ml /100g, e.g. 90 to 130 ml /100g, or 70 to 119 (or 120) ml /100g, when measured according to ASTM D 2414-19.

One group of suitable furnace blacks have a primary particle size of 28 nm or less. Particularly suitable furnace blacks of this category may have an iodine adsorption number between 60 and 300 mg/g. It is further suitable that the oil absorption number (of this category) is between 50 and 225 ml100g, for example between 50 and 200 ml/100g.

Other suitable carbon blacks can be made by any other process or can be further treated. Suitable carbon blacks for semiconductive cable layers are suitably characterized by their cleanliness. Therefore, suitable carbon blacks have an ash-content of less than 0.2 wt% measured according to ASTM D1506, a 325 mesh sieve residue of less than 30 ppmaccording to ASTM D1514 and have less than 3 wt%, preferably less than 1 wt% total sulphur according to ASTMD1619.

Furnace carbon black is a generally acknowledged term for the well-known carbon black type that is produced in a furnace-type reactor. As examples of carbon blacks, the preparation process thereof and the reactors, reference can be made to i.a. EP629222 of Cabot, U.S. Pat. Nos. 4,391,789, , 3,922,335 and 3,401,020. As an example of commercial furnace carbon black grades N115, N351, N293, N220 and N550 can be mentioned. To further increase the suitability of such carbon blacks in semiconductive compounds, modifications of these commercial carbon blacks e.g. in terms of cleanliness, pellet properties and surface area are advantageous. Furnace carbon blacks are conventionally distinguished from acetylene carbon blacks which are another carbon black type suitable for the semiconductive polymer composition.

Acetylene carbon blacks are produced in an acetylene black process, e.g. as described in U.S. Pat. No. 4,340,577. Particularly, acetylene blacks may have a particle size of larger than 20 nm, for example 20 to 80 nm. The mean primary particle size is defined as the average particle diameter according to the ASTM D3849-14. Suitable acetylene blacks of this category have an iodine adsorption number between 30 to 300 mg/g, for example 30 to 150 mg/g according to ASTM D1510. Further the oil absorption number (of this category) is, for example between 80 to 300 ml/100 g, e.g. 100 to 280 ml/100 g and this is measured according to ASTM D2414. Acetylene black is a generally acknowledged term and are very well known and e.g. supplied by Denka.

Ethylene Vinyl Acetate (c)

The ethylene vinyl acetate (c) is an ethylene vinyl acetate copolymer with an MFR₂ (2.16 kg, 190 ° C.) of at least 100 g/10 min. Typically, the MFR₂ of the ethylene vinyl acetate (c) is up to 1200 g/10 min, such as of up to 1000 g/10 min, preferably of up to 800 g/10 min. Thus, preferred ranges may include 100 to 1200, preferably 150 to 1000, more preferably 200 to 800 g/10 min, such as 250 to 600 g/10 min, e.g. 350 to 550 g/10 min.

The ethylene vinyl acetate (c) may be a high pressure polyethylene as defined above for the ethylene vinyl acetate copolymer (a), e.g. with additional polar comonomers. Typically, however, it is a high pressure LDPE, produced in an analogous manner as described above for the ethylene vinyl acetate copolymer (a).

The ethylene vinyl acetate employed as component (c) is different to the ethylene vinyl acetate copolymer (a). Thus, the ethylene vinyl acetate copolymer (a) must not be identical to the ethylene vinyl acetate copolymer (c).

The ethylene vinyl acetate copolymer (c) may comprise one or more additional comonomers as defined above for the copolymer (a). In one preferred embodiment, the ethylene vinyl acetate (c) consists of ethylene and vinyl acetate monomers.

Example vinyl acetate contents for the ethylene vinyl acetate (c) are 1 to 45 wt%, preferably 1 to 35 wt%, more preferably 2 to 30 wt%, even more preferably 3 to 25 wt%, such as 5 to 20 wt%, especially 10 to 20 wt% e.g. 11 to 19 wt% relative to the total weight of the ethylene vinyl acetate.

The ethylene vinyl acetate (c) is present in the semiconductive polymer compositions of the invention in an amount of at least 2 wt%, relative to the total weight of the composition as a whole. Preferable amounts may be in the range 2 to 30 wt%, more preferably 2 to 20 wt%, such as 5 to 15 wt%.

Ideally, the ethylene vinyl acetate (c) is not an EVA wax. For example, the average molecular weight may be above 8000 g/mol.

Polymer Composition

In addition to components (a) to (c) described above, the semiconductive polymer composition of the invention may comprise further components, typically additives, such as antioxidants, crosslinking boosters, scorch retardants, processing aids, fillers, coupling agents, ultraviolet absorbers, stabilizers, antistatic agents, nucleating agents, slip agents, plasticizers, lubricants, viscosity control agents, tackifiers, anti-blocking agents, surfactants, extender oils, acid scavengers and/or metal deactivators. These additives are well known in the industry and their use will be familiar to the artisan. Any additives which are present may be added as an isolated raw material or in a mixture with a carrier polymer, i.e. in so called master batch.

In a particularly preferred embodiment, the composition of the invention comprises an acid scavenger, which includes compounds which are metal salts of long chain carboxylic acids like metal stearates, lactates, natural or synthetic silicates like hydrotalcites, metal oxides (e.g. magnesium oxide, calcium oxide, zinc oxide), metal carbonates (e.g. calcium carbonate) and metal hydroxides . Ideally, the acid scavenger is a metal stearate, such as calcium stearate, zinc stearate, sodium stearate, lithium stearate or magnesium stearate. Zinc stearate is especially preferred.

If present, the acid scavenger typically forms at least 0.1 wt% of the total weight of the composition as a whole. Example amounts of the acid scavenger are thus 0.1 to 5.0 wt%, preferably 0.2 to 4.0 wt%, more preferably 0.3 to 3.0 wt%, such as 0.4 to 2.0 wt%, or 0.2 to 2.0 wt%, or 0.2 to 1 wt%, relative to the total weight of the polymer composition.

In a further preferable embodiment, the composition comprises an antioxidant. Examples of such antioxidants are as follows, but are not limited to: hindered phenols such as tetrakis[methylene(3,5-di-tert- butyl-4-hydroxyhydro-cinnamate)] methane; bis[(beta- (3,5-ditert-butyl-4-hydroxybenzyl)-methylcarboxyethyl)]sulphide, 4,4′-thiobis(2-methyl-6- tert-butylphenol), 4,4′-thiobis(2-tert-butyl-5-methylphenol), 2,2′-thiobis(4-methyl-6-tert- butylphenol), 2,2′-thiodiethylenebis-(3,5-di-tert. butyl-4-hydroxyphenyl)-propionate, 4,6- bis (octylthiomethyl)-o-cresol, and thiodiethylene bis(3,5-di-tert-butyl-4- hydroxy)hydrocinnamate; phosphites and phosphonites such as tris(2,4-di-tert- butylphenyl)phosphite and di-tert-butylphenyl- phosphonite; thio compounds such as dilaurylthiodipropionate, dimyristylthiodipropionate, and distearylthiodipropionate; various siloxanes; polymerized 2,2,4-trimethyl-1,2- dihydroquinoline (TMQ), n,n′-bis(1 ,4- dimethylpentyl-p-phenylenediamine), alkylated diphenylamines, 4,4′-bis(1,1′- diethylbenzyl)diphenylamine, diphenyl-p- phenylenediamine, mixed di-aryl-p- phenylenediamines, 2,2′-oxamido bis-(ethyl-3-(3,5-di-tert.butyl-4- hydroxyphenyl)propionate), and other hindered amine antidegradants or stabilizers. A more preferred antioxidant is 4,4′-bis(1,1′-dimethylbenzyl)diphenylamine. A particularly preferred antioxidant is TMQ.

Antioxidants can be used in amounts of 0.1 to 5.0 wt%, preferably 0.15 to 2 wt%, more preferably 0.2 to 1.5 wt%, even more preferably 0.25 to 1.0 wt%, such as 0.3 to 0.8 wt%, especially 0.35 to 0.7 wt%, based on the weight of the composition.

Examples of fillers as additives are as follows: clays, precipitated silica and silicates, fumed silica, calcium carbonate, ground minerals, and further carbon blacks. Fillers can be used in amounts ranging from less than about 0.01 to more than about 40 percent by weight based on the weight of the composition.

In embodiments wherein the semiconductive polymer composition is a crosslinkable composition, it may also comprise a crosslinking agent. Typical amounts of crosslinking agent are 0.01 to 4.0 wt%, preferably 0.02 to 2.0 wt%, more preferably 0.03 to 1.5 wt%, such as 0.05 to 1.2 wt%, especially 0.1 to 1.0 wt% relative to the total weight of the composition.

The preferred crosslinking agent is peroxide. Non-limiting examples are organic peroxides, such as di-tert-amylperoxide, 2,5-di(tert-butylperoxy)-2,5-dimethyl-3-hexyne, 2,5-di(tert-butylperoxy)-2,5-dimethylhexane, tert-butylcumylperoxide, di(tert- butyl)peroxide, dicumylperoxide, butyl-4,4-di(tert-butylperoxy)-valerate, 1,1-di(tert- butylperoxy)-3,3,5-trimethylcyclohexane, tert-butylperoxybenzoate, dibenzoylperoxide, di(tert butylperoxyisopropyl)benzene, 2,5-dimethyl-2,5-di(benzoylperoxy)hexane, 1,1- di(tert-butylperoxy)cyclohexane, 1,1-di(tert amylperoxy)cyclohexane, or any mixtures thereof. Preferably, the peroxide is selected from 2,5-di(tert-butylperoxy)-2,5- dimethylhexane, di(tert-butylperoxyisopropyl)benzene, dicumylperoxide, tert- butylcumylperoxide, di(tert-butyl)peroxide, or mixtures thereof.

Scorch retarders which may be employed in the present invention include unsaturated dimers of aromatic alpha-methyl alkenyl monomers, such as 2,4-di-phenyl-4- methyl-l-pentene, substituted or unsubstituted diphenylethylene, quinone derivatives, hydroquinone derivatives, monofunctional vinyl containing esters and ethers, monocyclic hydrocarbons having at least two or more double bonds, or mixtures thereof. For example, the scorch retarder may be selected from 2,4-diphenyl-4-methyl-1-pentene, substituted or unsubstituted diphenylethylene, or mixtures thereof.

Typically, the ethylene vinyl acetate copolymer (a) and the ethylene vinyl acetate (c) are the only polymer components present in the polymer composition. However, it is to be understood herein that the polymer composition may comprise further components such as additives which may optionally be added in a mixture with a carrier polymer, i.e. in so called master batch.

According to at least one example embodiment, the vinyl acetate content of component (a) is between 3.0 and 25 wt%, and the vinyl acetate content of component (c) is between 3.0 and 25 wt% and the amount of carbon black (b) in the semiconductive polymer composition is between 34 and 41 wt%. According to yet a further embodiment, the vinyl acetate content of component (a) is between 5.0 and 25 wt%, and the vinyl acetate content of component (c) is between 5.0 and 25 wt% and the amount of carbon black (b) in the semiconductive polymer composition is between 34 and 41 wt%. According to yet a further embodiment, the vinyl acetate content of component (a) is between 5.0 and 20 wt%, and the vinyl acetate content of component (c) is between 5.0 and 20 wt% and the amount of carbon black (b) in the semiconductive polymer composition is between 34 and 41 wt%. According to yet a further embodiment, the vinyl acetate content of component (a) is between 10 and 20 wt%, and the vinyl acetate content of component (c) is between 10 and 20 wt% and the amount of carbon black (b) in the semiconductive polymer composition is between 34 and 41 wt%. According to yet a further embodiment, the vinyl acetate content of component (a) is between 11 and 19 wt%, and the vinyl acetate content of component (c) is between 11 and 19 wt% and the amount of carbon black (b) in the semiconductive polymer composition is between 34 and 41 wt%.

Preparation of polymer composition

In a further aspect, the invention provides a process for preparing a semiconductive polymer composition comprising:

(a) at least 30 wt% of an ethylene vinyl acetate copolymer;

(b) at least 25 wt% carbon black; and

(c) at least 2 wt% of an ethylene vinyl acetate copolymer with an MFR₂ of at least 100 g/10 min and/or at least 0.1 wt% of an acid scavenger

said process comprising compounding (a) to (c) at a temperature of less than 240 ° C., with the proviso that the ethylene vinyl acetate copolymer (c) is different to the ethylene vinyl acetate copolymer (a).

A further embodiment of the present invention discloses a process for producing a semiconductive polymer composition as defined herein, the process comprising mixing and/or blending (e.g. compounding) components (a) to (c) at a temperature below 240 ° C. Preferable temperature ranges include 155 to 235 ° C., such as 160 to 230 ° C.

This mixing at elevated temperature is typically referred to as melt mixing, and will usually occur at more than 10° C. above, preferably more than 25° C., above the melting point of the polymer component(s) and below the undesired degradation temperature of the components.

Said temperature is typically the temperature as defined by the Measured temperature in the Determination Methods section.

The most preferred method of preparation involves compounding the various components, usually via extrusion.

Preferably said preparation process of the invention further comprises a step of pelletising the obtained polymer mixture. Pelletising can be affected in well known manner using a conventional pelletising equipment, such as preferably conventional pelletising extruder which is integrated to said mixer device. The process of the invention can be operated in batch wise or in continuous manner.

Apparatuses used for carrying out the method of the invention are for example single screw or twin screw mixer or a kneading extruder, or a combination thereof, which is preferably integrated to a pelletising device. The apparatus(es) may be operated in batch wise or, preferably, in continuous manner. The process may comprise a further subsequent sieving step before preferable pelletising step which is also conventionally used in the state of the art in the preparation of semiconductive polymer compositions to limit the number of large particles.

According to at least one example embodiment, such apparatus may be a co- kneader comprising a mixer barrel in which the melt-mixing of the composition is carried out, e.g. with one or more inlet hoppers for adding the carbon black, and a discharge extruder or gear pump arranged downstream of the mixer barrel. The co-kneader may e.g. be a single-screw machine comprising an axial oscillation once per revolution, where static pins in a mixer house of the apparatus interact with gaps in the screw. Hereby, an elongational kneading, which provides efficient dispersive and distributive mixing in a relatively short barrel, is provided. Temperature can be controlled by adding the carbon black to the polymer melt in one or more hoppers. The output may e.g. be a 3.5 tons/h and the RPM 750.

End Applications

A further embodiment of the present invention provides an article, preferably a cable (e.g. a power cable), comprising at least one layer, wherein said layer comprises the semiconductive polymer composition as described herein. A further embodiment of the present invention provides a layer in a multi-layer cable, such as a power cable layer, wherein said layer comprises the semiconductive polymer composition as described herein. The multi-layer cable may e.g. have at least 3 layers, such as e.g. an inner semiconductive layer, an outer semiconductive layer, and an insulation layer arranged there between.

The at least one layer of the cable comprising the semiconductive polymer composition is preferably a semiconductive layer.

Further, the cable of the present invention may, for example, be a power cable which comprises a conductor surrounded by at least a semiconductive layer comprising, preferably consisting of, the polymer composition of the invention.

Ideally, the cable will comprise a conductor surrounded by at least an inner semiconductive layer, an insulation layer and an outer semiconductive layer in given order, wherein the semiconductive layer(s) comprise, preferably consist of, the semiconductive polymer composition as described herein. It is within the ambit of the invention for the semiconductive polymer composition of the inner and outer semiconductive layer to be identical or different.

According to another embodiment of a power cable, the semiconductive layer(s) may be strippable or non-strippable, preferably non-strippable, i.e. bonded. These terms are known and describe the peeling property of the layer, which may be desired or not depending on the end application. Thus, according to at least one example embodiment, said layer is a bonded layer in said multi-layer cable, such as e.g. the inner or outer semiconductive layer arranged in contact with the conductor of the cable.

In case of a strippable semiconductive layer, the EVA copolymer of the invention is more polar having the content of polar comonomers of at least 20.0 wt%, such as at least 25.0 wt%, preferably at least 26.0 wt%, more preferably from 27.0 to 35.0 wt%, based on the weight of said EVA copolymer, and may contain further polar polymer components to contribute the strippability. Preferably a non-strippable semiconductive layer (e.g. the inner or outer layer) has a content of polar comonomers of less than 25.0 wt%, preferably less than 20.0 wt%, more preferable of from 10.0 to 18.0 wt%. In some embodiments the polar comonomer content as low as of 6.0 to 15.0 wt% based on said EVA copolymer may be desired. Thus, according to at least one example embodiment, the semicondutive polymer composition has a content of polar comonomers of less than 25.0 wt%, preferably less than 20.0 wt%, more preferable of from 10.0 to 18.0 wt% or as low as of 6.0 to 15.0 wt%, based on said EVA copolymer. In both strippable and non-strippable cases the layer is preferably crosslinkable.

According to at least one example embodiment, the semiconductive layer of the invention has a strip force of 8 kN/m or more, preferably more than 10 kN/m. The method used for measuring such strip force is well known and is e.g. described in the method section under “Strip force 90° ” in WO2019002449.

The term “conductor” means herein above and below that the conductor comprises one or more wires. Moreover, the cable may comprise one or more such conductors. Preferably the conductor is an electrical conductor and comprises one or more metal wires.

The cable of the invention is preferably a power cable selected from a MV, HV or EHV cable. The cable is preferably a MV cable, HV cable or EHV cable.

Insulating layers for medium or high voltage power cables generally have a thickness of at least 2 mm, typically of at least 2.3 mm, and the thickness increases with increasing voltage the cable is designed for.

As well known the cable can optionally comprise further layers, e.g. layers surrounding the insulation layer or, if present, the outer semiconductive layers, such as screen(s), a jacketing layer(s), other protective layer(s) or any combinations thereof.

The cable of the invention may be crosslinkable. Accordingly, further preferably the cable is a crosslinked cable, wherein at least one semiconductive layer comprises crosslinkable polymer composition of the invention which is crosslinked before the subsequent end use.

The most preferred cable of the invention is a power cable which is preferably crosslinkable. Such a power cable ideally comprises a conductor surrounded by at least an inner semiconductive layer, an insulation layer and an outer semiconductive layer in given order, wherein the semiconductive layer(s) comprises, preferably consists of, the semiconductive polymer composition as described herein. Preferably at least the inner semiconductive layer comprises the polymer composition of the invention, as defined above or below, or in claims, including the preferred embodiments thereof. In this preferred embodiment of cable, the outer semiconductive layer may optionally comprise the polymer composition of the invention which can be identical or different from the polymer composition of the inner semiconductive layer. Moreover, at least the polymer composition of the invention of the inner semiconductive layer is crosslinkable, preferably peroxide crosslinkable, and is crosslinked before the subsequent end use. Preferably also the insulation layer is crosslinkable and is crosslinked before the subsequent end use. The outer semiconductive layer may optionally be crosslinkable and thus be non-crosslinked or crosslinked, depending on the desired end application.

The invention further provides a process for producing a cable, preferably a power cable, wherein the process comprises the steps of:

applying on one or more conductors, a layer comprising a semiconductive composition as defined herein.

According to at least one example embodiment, the process for producing a cable comprises the steps of:

(i) providing and mixing, preferably meltmixing in an extruder, a polymer composition, preferably in the form of pellets, as hereinbefore defined;

(ii) applying a meltmix of the polymer composition obtained from step (i), preferably by (co)extrusion, on a conductor to form at least one semiconductive layer; and

(iii) optionally, and preferably, crosslinking the obtained at least one semiconductive layer in the presence of the crosslinking agent.

In a further embodiment, the invention comprises a process for producing a cable, preferably a power cable, wherein the process comprises the steps of:

(i) providing and mixing, preferably meltmixing in an extruder, a first semiconductive composition as hereinbefore defined, preferably in the form of pellets, for the inner semiconductive layer,

providing and mixing, preferably meltmixing in an extruder, a polymer composition for the insulation layer,

providing and mixing, preferably meltmixing in an extruder, a second semiconductive composition comprising a polymer, a carbon black and optionally further component(s), preferably in the form of pellets, for the outer semiconductive layer;

(ii) applying on a conductor, preferably by coextrusion,

a meltmix of the first semiconductive composition obtained from step (i) to form the inner semiconductive layer,

a meltmix of polymer composition obtained from step (i) to form the insulation layer, and

a meltmix of the second semiconductive composition obtained from step (i) to form the outer semiconductive layer,

wherein at least one of the first semiconductive composition of the obtained inner semiconductive layer and the second semiconductive composition of the obtained outer semiconductive layer, preferably at least the first semiconductive composition of the obtained inner semiconductive layer, comprises, preferably consists of, a polymer composition of the invention.

The term “(co)extrusion” means herein that in case of two or more layers, said layers can be extruded in separate steps, or at least two or all of said layers can be coextruded in a same extrusion step, as well known in the art. The term “(co)extrusion” means herein also that all or part of the layer(s) are formed simultaneously using one extrusion head, or sequentially using more than one extrusion heads.

As well known a meltmix of the polymer composition or component(s) thereof, is applied to form a layer. The mixing step can be carried out in the cable extruder. The meltmixing step may comprise a separate mixing step in a separate mixer, e.g. kneader, arranged in connection and preceding the cable extruder of the cable production line. Mixing in the preceding separate mixer can be carried out by mixing with or without external heating (heating with an external source) of the component(s).

In general, carbon black (b) and the ethylene vinyl acetate (c) are mixed with the ethylene vinyl acetate copolymer (a), e.g. by meltmixing, and the obtained meltmix is pelletized to pellets for use in the cable production methods described above. Pellets mean herein generally any polymer product which is formed from a reactor-made polymer (obtained directly from the reactor) by post-reactor modification to solid polymer particles. Pellets can be of any size and shape. The obtained pellets are then used for cable production.

All or part of the optional other component(s), such as further polymer component(s) or additive(s) can be present in the polymer composition before providing to the mixing step (i) of the cable preparation process or can be added, e.g. by the cable producer, during the mixing step (i) of the cable production process.

If, and preferably, the polymer composition is crosslinked after cable formation, then the crosslinking agent is preferably a peroxide, which can be mixed with the components of the polymer composition before or during mixing step (i). Preferably, the crosslinking agent, preferably peroxide, is impregnated to the solid polymer pellets of the polymer composition. The obtained pellets are then provided to the cable production step.

Most preferably, the polymer composition of the invention is provided to the mixing step (i) of the cable production process in a suitable product form, such as a pellet product.

In case the polymer composition is silane crosslinkable then the crosslinking agent is typically not present in the polymer composition before the cable formation, but the crosslinking agent is usually added to the insulation layer composition and after cable is formed the crosslinking agent migrates during the crosslinking step to the semiconductive layer comprising the polymer composition of the invention.

In the preferred cable production process the obtained cable is crosslinked in step (iii).

As mentioned, the polymer composition is preferably crosslinkable and preferably the pellets of the polymer composition comprise also the peroxide before providing to the cable production line.

In above crosslinking process step (iii) of the invention crosslinking conditions can vary depending i.a. on the used crosslinking method, and cable size. The crosslinking of the invention is effected e.g. in a known manner preferably in an elevated temperature. A skilled person can choose the suitable crosslinking conditions e.g. for crosslinking via radical reaction or via hydrolysable silane groups. As non-limiting example of a suitable crosslinking temperature range, e.g. at least 150° C. and typically not higher than 360° C.

Determination Methods

Unless otherwise stated in the description or experimental part the following methods were used for the property determinations.

Wt% =weight percent

Melt Flow Rate: The melt flow rate (MFR) is determined according to ISO 1133 and is indicated in g/10 min. The MFR is an indication of the flowability, and hence the processability, of the polymer. The higher the melt flow rate, the lower the viscosity of the polymer. The MFR is determined at 190 ° C. for polyethylene. MFR may be determined at different loadings such as 2.16 kg (MFR₂) or 21.6 kg (MFR₂₁).

Density: Low density polyethylene (LDPE): The density was measured according to ISO 1183-2. The sample preparation was executed according to ISO 1872-2 Table 3 Q (compression moulding).

Surface smoothness: Surface Smoothness Analysis (SSA) method uses a tape sample consisting of the semiconductive polymer composition as described below, and is a well-known method used in the prior art for determining the surface smoothness of semiconductive polymer materials.

Surface Smoothness Analysis (SSA) is designed to measure and record surface irregularities, called pips, on the extruded semiconductive material. The method is used for analysis directly linked to production, so called on-line analysis. The SSA equipment measures and sorts pips of different sizes based on the half-height width. Depending on the product there is a specified maximum number of pips in each size-class. The principle of detection of pips with SSA is measurment of the tape shadow over a horizon. The extruded tape passes a shear pin which is illuminated from one side with a light source. If a pip or other defect occur on the surface it gives rise to a shadow which is recorded on a one- dimensional camera located on the other side of the tape. The camera consists of light- sensitive pixels which measure the height and width of the defect. The height of the amount of light that passes the horizon and the width by the number of pixels that are shaded are recorded and detected as pips. Detected pips are reported in the magnitude of half-height width (W50) and height (h) in different size with the unit number of pips per square parsed tape (no / m²). The definition of half-height width is the width the pips have at half the height. The test system is further generally described e.g. in WO0062014 of Semyre.

Tape sample preparation

About 4 kg of pellets of the semiconductive polymer composition were taken and extruded into a form of tape sample using Collin single screw of 20 mm and 25D extruder (supplier Collin) and following temperature settings at different sections, starting from the inlet of the extruder: 95 ° C., 120 ° C. , 120 ° C. and 125 ° C. to obtain a temperature of 125 ° C. of the polymer melt. The pressure before the extrusion plate is typically 260 bar (26 MPa), residence time is kept between 1 and 3 minutes and typical screw speed is 50 rpm, depending on the polymer material as known for a skilled person.

Extruder die opening: 30 mm x 1 mm

Thickness of the tape: 500φ±20μm

Width of the tape: 18 mm

The tape is cooled with air to solidify it completely before subjecting to a camera- scanning (detection) zone of the SSA-instrument which locates at a distance of 50 cm from the outlet of die.

The measurement area: Camera of SSA-instrument scans the tape surface while the tape moves with a given speed. The scanning width is set to exclude the edge area of the tape. The scanning is effected on along the tape to correspond to a measurement area of 1 m2. Further details are given below.

SSA determination of the tape sample

The test is based on an optical inspection of the obtained extruded tape that is passed in front of an optical scanner able to scan even a large surface at high speed and with good resolution. The SSA-instrument is fully computerised and during the operation it automatically stores information about positions and sizes of pips found for statistical evaluation. “Pip” means herein a smaller burl with a height at least one order of magnitude higher than the surrounding background roughness. It is standing alone and the number per surface area is limited.

Height is the distance between the base line (=surface of the tape) and the highest point of a pip. Half height is defined as the width of the pip at 50% of its height (W50) measured from the baseline. For the half height measurement the surface of the tape sample is taken as the baseline. Pip is referred herein above and below as a “particle protruding, from the surface of the tape”. And thus the “half height of said particle protruding from the surface of the tape sample” as used herein in the description and claims is said half height width (W50).

The instrument was SSA-analysing instrument of Semyre Photonic Systems AB, Sweden.

Hardware: PC via Image Pre Processor

Software: NOPINIT

Camera type: spectrofotograph camera from Dalsa with 2048 pixels. It was on-line camera with line frequency of 5000.

Light source: intensity regulated red LED.

The width resolution of the pip (particle): 10 μm

The height resolution of the pip (particle): 1.5 μm

Tape speed in SSA-instrument: 50 mm/s

The horizon of tape surface is created of a rotating metal shaft. The light source and camera are directly aligned with no angel with a focal point on the horizon.

The scanning results are for 1 m2 area of tape and expressed as

number of particles per m2 having a width larger than 150 μm at a half height of said particle protruding from the tape surface (=baseline),

number of particles per m2 having a width larger than 200 μm at a half height of said particle protruding from the tape surface (=baseline), and

number of particles per m2 having a width larger than 500 μm at a half height of said particle protruding from the tape surface (=baseline).

The given values represent an average number of particles obtained from 10 tape samples prepared and analysed for a semiconductive composition under determination.

Measured temperature: The temperature was measured on the semicondcutive polymer composition in the compounding apparatus (a BUSS MX 140 mixer), subsequent to adding the carbon black and prior to the discharge extruder. The temperature was measured for an output of 2000 kg/h and an RPM of about 430.

Experimental part

The following components were used:

EVA copolymer (a): A commercially available copolymer of ethylene with vinyl acetate (Elvax 550A) produced in a tubular reactor of a high pressure polymerisation process, MFR (190° C., 2.16 kg) of 8 g/10 min, vinyl acetate (VA) content of 15 wt%.

Carbon black (b): A commercially available P-type furnace black (Printex Alpha A) with the following properties:

Iodine number : 112-124 [mg/g] (ASTM D1510-19)

Oil absorption number: 92-104 [ml/100g] (ASTM D2414-19)

Mean Primary Particle size: 11- 20 nm (ASTM D3849-14)

Ethylene vinyl acetate (c): A commercially available high MFR EVA (Repsol Primeva P18500) with 18%-wt of VA comonomer content and a MFR (190° C., 2.16 kg) of 500 g/10 min.

Ethylene vinyl acetate (d) has been produced as described below.

A mixture of fresh ethylene and recycled ethylene, chain transfer agent (l-propylene) and vinylacetate was compressed to reach an initial reactor pressure of 2600 bars. The total hyper compressor throughput was ca. 30 tons/hour. In the compressor area propylene was added as chain transfer agent in amounts to maintain an MFR₂ of around 500 g/10 min. Here vinyl acetate was added as well in amounts to reach 15 wt% vinyl acetate in the ethylene vinyl acetate. The compressed mixture was heated to 135 ° C. in a preheating section before entering a split feed 2 zone tubular reactor with a varying L/D between around 17300 to 30400. Mixtures of commercially available peroxide radical initiators dissolved in an inert solvent were injected after the preheating section and at one more position along the reactor in amounts sufficient for the exothermal polymerisation reaction to reach peak temperatures of 262 ° C. and 262 ° C., respectively, with cooling in-between to 155 ° C. The reaction mixture was depressurised by a pressure control valve, cooled and the polymer was separated from unreacted gas.

The obtained polymer has a VA comonomer content of 15 wt% and a MFR₂ of (190° C., 2.16 kg) of 500 g/10 min.

Acid scavenger: A commercially available zinc stearate (Zinkum)

Antioxidant 1: TMQ: polymerized 2,2,4-trimethyl-1,2-dihydroquinoline, melt point: 80-135° C., CAS:26780-96-1

Antioxidant 2: 4,4′-bis(1,1′-dimethylbenzyl)diphenylamine, melt point: 98- 100° C., CAS: 10081-67-1

Four inventive and one reference composition were prepared with constituents as shown in Table 1. The compositions were compounded by means known to those skilled in the art. In these examples, the compounding equipment included a continuous single screw BUSS MX 140 mixer. The compounding temperatures for Inventive compositions 1, 2 and 4 as well as the reference composition are shown in Table 2. The smoothness result for Inventive composition 3 is shown in Table 3.

TABLE 1
Inventive and comparative examples (all contents in wt %).

| | EVA | Carbon | Acid | | | Anti- | Anti- |
|---|---|---|---|---|---|---|---|
| | copolymer (a) | black | scavenger | EVA (c) | EVA (d) | oxidant 1 | oxidant 2 |
| Reference | 61.2 | 38 | — | — | — | 0.8 | — |
| composition A | | | | | | | |
| Inventive | 60.8 | 38 | 0.4 | — | — | 0.8 | — |
| composition 1 | | | | | | | |
| Inventive | 51.8 | 38 | 0.4 | 9 | — | 0.8 | — |
| composition 2 | | | | | | | |
| Inventive | 54.9 | 38 | 0.6 | 6.5 | — | 0.8 | — |
| composition 3 | | | | | | | |
| Inventive | 54.7 | 38 | 0.4 | — | 6.5 | — | 0.4 |
| composition 4 | | | | | | | |

TABLE 2
Measured temperature of the semi conductive
polymer composition in the compounding step

| | Temperature (° C.) |
|---|---|
| Reference composition A | 240 |
| Inventive composition 1 | 222 |
| Inventive composition 2 | 200 |
| Inventive composition 4 | 194 |

TABLE 3
Smoothness

| | SSA (pips > 0.15) |
|---|---|
| Inventive composition 3 | 9.9 |

A surface smoothness of 9.9 as measured in Table 3 is appropriate for semiconductive polymer composition designed for commercial application in cables.

Eight additional inventive compositions and one further reference composition were prepared with constituents as shown in Table 4. The compositions were compounded on an X-Compound CK 45 machine (25 kg/h and 300 RPM). The kneader power required during compounding is also shown in Table 4. It is surprisingly observed that when a semiconductive composition containing high MFR EVA component is produced the kneader power requirement is reduced. The output for the kneader is the same for all compositions.

TABLE 4
Further example compositions and power consumptions (all contents in wt %).

| | | Carbon | Acid | | | Kneader Power |
|---|---|---|---|---|---|---|
| | EVA (a) | black | scavenger | EVA (c) | Antioxidant | consumption (kW) |
| Reference | 57.35 | 39 | 3 | — | 0.65 | 6.7 |
| composition B | | | | | | |
| Inventive | 55.35 | 39 | 3 | 2 | 0.65 | 6.5 |
| composition 5 | | | | | | |
| Inventive | 53.35 | 39 | 3 | 4 | 0.65 | 6.5 |
| composition 6 | | | | | | |
| Inventive | 51.35 | 39 | 3 | 6 | 0.65 | 5.9 |
| composition 7 | | | | | | |
| Inventive | 49.35 | 39 | 3 | 8 | 0.65 | 6.2 |
| composition 8 | | | | | | |
| Inventive | 47.35 | 39 | 3 | 10 | 0.65 | 6.2 |
| composition 9 | | | | | | |
| Inventive | 45.35 | 39 | 3 | 12 | 0.65 | 5.9 |
| composition 10 | | | | | | |
| Inventive | 42.35 | 39 | 3 | 15 | 0.65 | 5.7 |
| composition 11 | | | | | | |
| Inventive | 37.35 | 39 | 3 | 20 | 0.65 | 5.2 |
| composition 12 | | | | | | |

1. A semiconductive polymer composition comprising:
a) at least 30 wt% of an ethylene vinyl acetate copolymer;
b) at least 25 wt% of carbon black; and
c) at least 2 wt% of an ethylene vinyl acetate copolymer with an MFR₂ of at least 100 g/10 min;
with the proviso that components (a) and (c) are different.

2. The semiconductive polymer composition as claimed in claim 1, wherein the carbon black has an iodine adsorption number of at least 10 mg/g, when determined according to ASTM D-1510-19; and/or an oil absorption number of at least 30 ml /100g, when measured according to ASTM D 2414-19.

3. The semiconductive polymer composition as claimed in claim 1, wherein the ethylene vinyl acetate copolymer (a) has a vinyl acetate content of 1 to 35 wt%, relative to the total weight of the copolymer.

4. The semiconductive polymer composition as claimed in claim 1, wherein the ethylene vinyl acetate copolymer (a) has an MFR₂ which is less than the MFR₂ of the ethylene vinyl acetate copolymer (c), and is from 0.01 to 50, g/10 min.

5. The semiconductive polymer composition as claimed in claim 1, wherein the ethylene vinyl acetate copolymer (a) is present in an amount of 30 to 73 wt%.

6. The semiconductive polymer composition as claimed in claim 1, wherein carbon black (b) is present in an amount of 25 to 60 wt%; and/or the ethylene vinyl acetate (c) is present in an amount of 2 to 30 wt%.

7. The semiconductive polymer composition as claimed in claim 1, further comprising at least 0.1 wt% of an acid scavenger, and/or further comprising an antioxidant and/or a crosslinking agent.

8. The semiconductive polymer composition as claimed in claim 1, wherein the ethylene vinyl acetate (c) has a vinyl acetate content of 1 to 45 wt%, relative to the total weight of the ethylene vinyl acetate.

9. The semiconductive polymer composition as claimed in claim 1, wherein the ethylene vinyl acetate (c) has an MFR₂ (2.16 kg, 190 ° C.) of 100 to 1200, g/10 min.

10. An article comprising semiconductive layer(s) which is/are obtained from a semiconductive polymer composition of claim 1.

11. A process for preparing a semiconductive polymer composition comprising:
a) at least 30 wt% of an ethylene vinyl acetate copolymer;
b) at least 25 wt% of carbon black; and
c) at least 2 wt% of an ethylene vinyl acetate copolymer with an MFR₂ of at least 100 g/10 min and/or at least 0.1 wt% of an acid scavenger
said process comprising compounding (a) to (c) at a temperature of less than 240 ° C., with the proviso that, when present, the ethylene vinyl acetate copolymer (c) is different to the ethylene vinyl acetate copolymer (a).

12. The process as claimed in claim 11, wherein the semiconductive polymer composition comprises both an ethylene vinyl acetate copolymer with an MFR₂ of at least 100 g/10 min and an acid scavenger as component (c).

13. The process as claimed in claim 11, wherein the acid scavenger is a metal stearate.

14. The process as claimed in claim 2, wherein the carbon black has an iodine adsorption number of at least 10 mg/g when determined according to ASTM D-1510-19; and/or an oil absorption number of at least 30 ml /100g when measured according to ASTM D 2414-19 .

15. A method for for reducing the compounding temperature of a semiconductive polymer composition, wherein the semiconductive polymer composition comprises an ethylene vinyl acetate copolymer with an MFR₂ of at least 100 g/10 min and/or an acid scavenger.

16. The semiconductive polymer composition of claim 7, wherein the acid scavenger is metal stearate.

17. The semiconductive polymer composition of claim 16, wherein the metal stearate is zinc stearate.

18. The process of claim 14, wherein the semiconductive polymer composition further comprises at least 0.1 wt% of an acid scavenger and/or further comprises an antioxidant and/or a crosslinking agent.

19. The process of claim 14, wherein the ethylene vinyl acetate (c) has a vinyl acetate content of 1 to 45 wt% relative to the total weight of the ethylene vinyl acetate.

20. The article of claim 10, wherein the article is a power cable.
